(19) United States
(12) Patent Application Publication
(10) Pub. No.: US 2015/0369261 A1
(43) Pub. Date: Dec. 24, 2015

(54) HYDRAULIC DRIVE SYSTEM

(71) Applicant: CATERPILLAR PAVING PRODUCTS INC., Brooklyn Park, MN (US)

(72) Inventor: Michael W. Ries, Coon Rapids, MN (US)

(21) Appl. No.: 14/307,727

(22) Filed: Jun. 18, 2014

(51) Int. Cl. F15B 11/04; F15B 21/08; F15B 19/00

(52) U.S. Cl. CPC F15B 11/04; F15B 19/00; F15B 21/08; F15B 2211/633; F15B 2211/66; F15B 2211/20546; F15B 2211/20507

(57) ABSTRACT

A drive system includes a variable displacement pump and a variable displacement motor hydraulically driven by the pump. A controller is configured to determine a motor displacement command to shift the motor displacement, and a pump displacement command to change the pump displacement. The controller modifies the motor and pump displacement commands based on hydraulic fluid temperature, the grade on which the machine is travelling and the speed of the prime mover. The controller further coordinates transmittal of the pump and motor displacement commands to maintain the travel speed of the machine while changing the displacements of the pump and motor.

### TECHNICAL FIELD

This disclosure relates to machine drive systems having hydraulic transmissions that include at least one variable displacement pump, at least one hydraulic motor and a controller programmed with a shift logic that accounts for a plurality of operating and environmental parameters for smooth transition between machines speeds and improved control of the machine speed.

### BACKGROUND

Machines such as wheeled compactors, loaders, trucks, and other machines are used to perform a variety of tasks. Such machines require an engine that provides a significant amount of torque through a transmission to one or more ground engaging traction devices. Such machines often include conventional manual or automatic transmissions having a discrete number of step-changed output ratios (gears) to control the speed and torque of the ground engaging devices. The output ratios correspond to travel speed ranges, with each range having a predefined maximum travel speed.

Conventional manual and automatic transmissions may be replaced by hydraulic transmissions that provide an infinitely variable torque-to-speed output ratio within the overall range of the transmission. Hydraulic transmissions typically pair a variable displacement pump and a fixed or a variable-displacement motor. In some hydraulic transmissions, the displacement of the motor must be set before operating the machine. In other hydraulic transmissions, the motor displacement is variable during operation, but varying the motor displacement during operation may result in momentary acceleration or deceleration of the machine.

U.S. Pat. No. 3,732,755 discloses a hydraulic transmission having a logic circuit that controls solenoid valves disposed between the pump and motor in response to a combination of operating parameters. The transmission of the '755 patent includes an electric pulse generator, which is coupled to the driven shaft of the transmission to measure the machine speed by producing a train of rate pulses of a cadence proportional to machine speed. An accumulator stage counts the number of rate pulses occurring within a certain period determined by an associated timing stage. The count of these rate pulses is fed to an actuating circuit, which operates the conventional gear-shifting mechanism to attain a desired machine speed, by the accelerating or decelerating machine.

### SUMMARY

In one aspect, a drive system for a machine is disclosed. The disclosed drive system may include a prime mover coupled to a variable displacement pump. The pump hydraulically drives a variable displacement motor with hydraulic fluid. The disclosed drive system further includes a controller communicatively linked to the motor, the pump, a travel speed sensor, an operator interface, a hydraulic fluid temperature sensor, a grade sensor, and a prime mover speed sensor. The controller may be configured to determine a travel speed of the machine from at least one signal communicated to the controller from the travel speed sensor. The controller may further be configured to determine a command speed of the machine based on operator input communicated to the controller from the operator interface. The controller may further be configured to compare the commanded speed to the travel speed, and if the travel speed differs from the commanded speed by more than the predetermined amount, the controller may be configured to determine a motor displacement command to change the displacement of the motor and determine a pump displacement command to change a displacement of the pump. Further, the controller may be configured to apply at least one modifier to at least one of the motor displacement command and the pump displacement command. The at least one modifier may be selected from the group consisting of: a hydraulic fluid temperature modifier based on at least one signal communicated to the controller from the hydraulic fluid temperature sensor; a grade modifier based on at least one signal communicated to the controller from the grade sensor; and a primer mover speed modifier based on at least one signal communicated to the controller from the prime mover speed sensor.

In another aspect, a controller-implemented method of driving a machine is disclosed. The disclosed method may include determining a travel speed of the machine and driving a variable displacement pump with a prime mover operating at a prime mover speed. The method may further include determining a pump displacement command to change a displacement of the pump. The method may further include hydraulically driving a variable displacement motor with pressurized hydraulic fluid delivered by the pump. The motor may be adjustable between at least a first displacement and a second displacement. The method may further include determining a motor displacement command to shift the motor from the first motor displacement to the second motor displacement. The method may further include detecting at least one operating variable selected from the group consisting of: hydraulic fluid temperature; grade on which the machine is traveling; and speed of the prime mover. The method may further include applying at least one modifier to at least one of the motor displacement command and the pump displacement command. The at least one modifier may be selected from the group consisting of: a hydraulic fluid temperature modifier based on the hydraulic fluid temperature; a grade modifier based on the grade on which the machine is traveling; and a prime mover speed modifier based on the speed of the prime mover.

In yet another aspect, a machine is disclosed. The machine may include a prime mover coupled to a variable displacement pump. The pump may drive a variable displacement motor with hydraulic fluid. The motor may include at least a first motor displacement and a second motor displacement. The motor may drive at least one traction device. The machine may further include a controller that is communicatively linked to motor, the pump, a prime mover speed sensor, a travel speed sensor, a grade sensor, a hydraulic fluid temperature sensor and an operator interface. The controller may be configured to determine a travel speed of the machine from at least one signal communicated to the controller from the travel speed sensor. The controller may be further configured to determine a commanded speed of the machine based on operator input communicated to the controller from the operator interface. The controller may be further configured to compare the commanded speed to the travel speed, and if the travel speed differs from the commanded speed by more than a predetermined amount, the controller may be configured to determine a motor displacement command to change displacement of the motor from a first motor displacement to a second motor displacement and to determine a pump displacement command to change displacement of the pump from a first pump displacement to a second pump displacement. The controller may also be configured to determine if a temperature of a hydraulic fluid falls outside of a predetermined temperature range based on the at least one signal communicated to the controller from the hydraulic fluid temperature sensor. If the temperature of the hydraulic fluid falls above or below the predetermined temperature range, the controller may be configured to apply a temperature modifier to at least one of the pump or motor displacement commands. The controller may be further configured to determine if the machine is traveling on a non-horizontal grade based on at least one signal communicated to the controller from the grade sensor and, if the machine is traveling on a non-horizontal grade, the controller may be configured to determine and apply the grade modifier to at least one of the motor or pump displacement commands. The controller may be further configured to determine if an actual speed of the prime mover falls within a predetermined range that includes a desired speed of the prime mover. The desired speed of the prime mover may be calculated from the operator input and if the actual speed of the prime mover does not fall within the predetermined range, the controller may be configured to determine and apply a prime mover speed modifier to at least one of the motor or pump displacement commands. The controller may be further configured to coordinate transmittal of the pump and motor displacement commands to maintain the travel speed of the machine while changing the displacement of the pump from the first to the second pump displacement and while changing the displacement of the motor from the first to the second motor displacement.

### BRIEF DESCRIPTION OF THE DRAWINGS

FIG. 1 is a perspective view of a machine incorporating the concepts disclosed herein;

FIG. 2 is a diagrammatic illustration of one disclosed drive system, an operator interface and a controller for use with the machine of FIG. 1; and

FIG. 3 is a flowchart of a method for operating the drive system of FIG. 2 in response to signals received from the controller.

### DETAILED DESCRIPTION

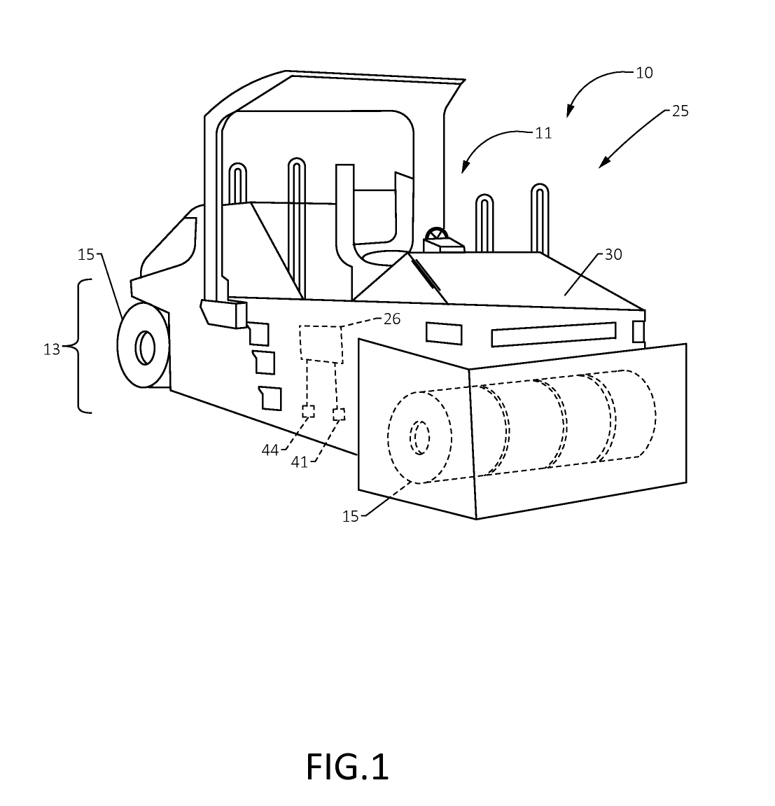

FIG. 1 illustrates an exemplary machine 10 having multiple systems and components that cooperate to accomplish various tasks. The tasks performed by the machine 10 may be associated with a particular industry such as paving, mining, construction, farming, transportation, or another industry known to those skilled in the art. For example, the machine 10 may be a wheeled compactor as depicted in FIG. 1, an on- or off-highway haul truck, a loader, or any other type of mobile machine known in the art. The machine 10 may include an operator station 11, from which an operator may control the machine 10. The machine 10 may also include a hydraulic drive system 13 operatively connected to one or more driven and/or steerable traction devices 15, such as, for example, wheels, drums, tracks, or belts located on each side or at the front of the machine 10.

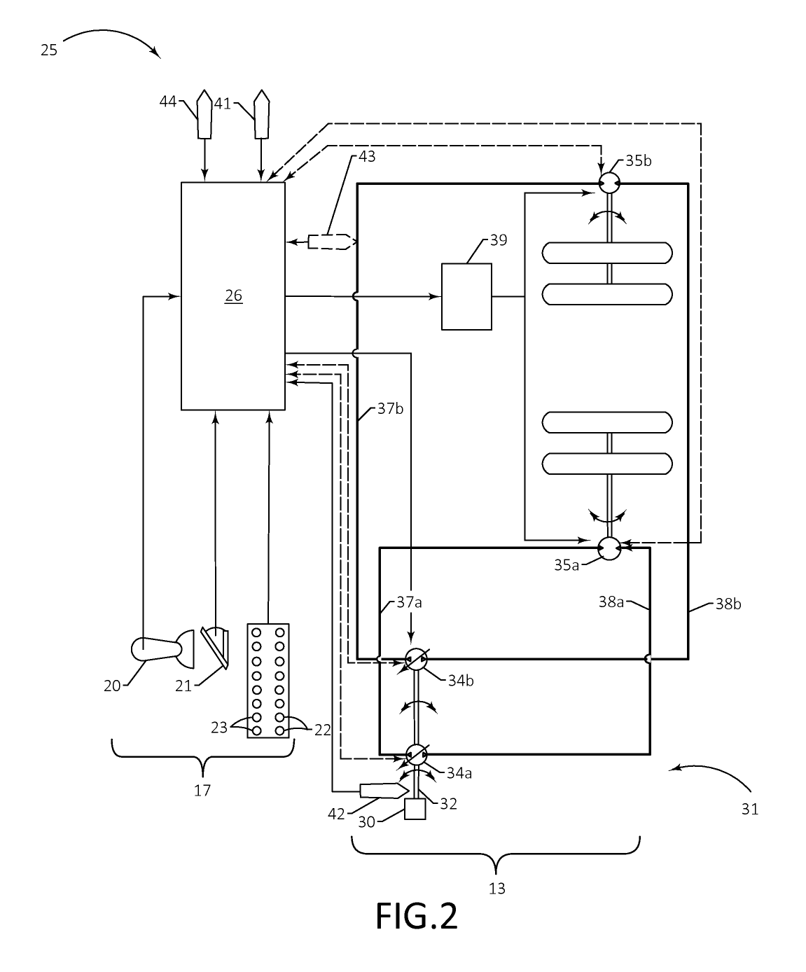

As illustrated in FIG. 2, an operator station 11 may include an operator interface 17 proximate to an operator seat (not shown) for generating machine command signals indicative of desired machine maneuvers and/or functions in response to operator input. The operator interface 17 may include a plurality of input devices including a throttle input 20, a brake input 21, a transmission input 22, and a speed input 23. Additional operator input devices may be included, if desired. Each input device may take the form of a joystick, pedal, a push-button, a knob, a switch, or another device. The operator may manipulate the input device to affect corresponding operations of the machine 10.

The throttle input 20 is depicted as a joystick that is tiltable through a range from a neutral position to one or more maximum displacement positions to generate one or more corresponding throttle input signals that are indicative of a desired percentage of the maximum speed of the machine in particular directions. As described below, the machine 10 may be configured so that the maximum speed of the machine 10 may be set or adjusted by an operator or other personnel. The throttle input 20 may be tiltable from the neutral position to a maximum displaced position in a first direction (e.g. forward) to generate a corresponding first throttle signal. Likewise, the throttle input 20 may be tiltable from the neutral position to a maximum displaced position in a second direction (e.g., rearward) to generate a second throttle signal. Values of the first and second throttle signals may correspond to desired percentages of the maximum speed setting for the machine in the forward and reverse directions of travel of the machine, respectively. In other words, the displacement of the throttle input 20 may be directly proportional to the percentage of the maximum speed of the machine based upon a setting or command from an operator or other personnel or as otherwise set within the machine 10.

The brake input 21 is depicted as a foot pedal that is pivotable through a range from a neutral position to a maximum displaced position to generate one or more corresponding displacement signals indicative of a desire to decelerate or reduce the speed of the machine 10. The displacement signals generated by the brake input 21 may be used to slow the machine 10 either by reducing the throttle input command from the throttle input 20, by applying service brakes (not shown), or by a combination of the two.

The transmission input 22 and the speed input 23 may be used by an operator to select different modes of operation. Specifically, the transmission input 22 may be a touch pad having a plurality of push buttons that, when pressed by the operator of the machine 10, select one of any number of available transmission control settings (i.e., virtual gears or portions of a continuous range of transmission speed-to-torque ratios). For example, the operator may press a first of the push buttons to select a first gear, in which the hydraulic drive system 13 may operate within a highest torque output range and a corresponding lowest travel speed range. Likewise, the operator may press a second of the push buttons to select a second or higher gear, in which the hydraulic drive system 13 may operate with a lower torque output range and a corresponding higher travel speed range.

The speed input 23 may also be a touch pad having a plurality of push buttons that, when pressed by the operator of the machine 10, select one of any number of maximum allowable speeds or available machine travel speed limits that correspond to the maximum displaced position of the throttle input 20. For example, if the actual maximum travel speed of the machine 10 is 19 kilometers per hour, each of the push buttons may set a reduced maximum travel speed at some speed less than 19 kilometer per hour. Other manners of setting maximum speeds of the machine 10 are contemplated and will be apparent to those skilled in the art. For example, setting the transmission input 22 to a first gear will have the affect of limiting the maximum speed to a number less than the maximum travel speed of the machine 10 when using a second gear.

Referring to FIG. 2, the machine 10 may include a control system 25. The control system 25 may be operatively connected to the various input devices to control the machine 10 and one or more sensors 41-44 to provide data and input signals representative of various operating parameters of the machine 10. The control system 25 may include an electronic control module or controller 26. The term “sensor” is meant to include one or more sensors and related components that may be associated with the machine 10 and that may cooperate to sense various functions, operating conditions and operating characteristics of the machine including, but not limited to machine speed (sensor 41), temperature of the hydraulic fluid (sensor 43), engine or prime mover speed (sensor 42), and the grade of the terrain upon which the machine is operating (sensor 44). Other functions, operating characteristics and operating conditions may be sensed, as will be apparent to those skilled in the art.

The controller 26 may be an electronic controller that operates in a logical fashion to perform operations, execute control algorithms, store and retrieve data and other desired operations. The controller 26 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 26 such as power supply circuitry, signal conditioning circuitry, driver circuitry, and other types of circuitry.

The controller 26 may be a single controller or may include more than one controller disposed to control various functions and/or features of the machine 10. The controller 26 may include one or more controllers and/or microprocessors that may be associated with the machine 10 and that may cooperate in controlling various functions and operations of the machine. The controller 26 may rely on one or more data maps relating to the operating conditions of the machine 10 that may be stored in the memory of controller 26. Each of these data maps may include a collection of data in the form of tables, graphs, and/or equations.

The controller 26 may be in communication with a hydraulic drive system 13 and an operator interface 17. The controller 26 may be configured to control operation of the hydraulic drive system 13 in response to signals received from the operator via the operator interface 17. Communications between the controller 26 and the other components of the machine 10 may be facilitated by communication links and other suitable network architecture.

Referring to FIG. 2, the hydraulic drive system 13 may include components that cooperate to generate and transmit power to the traction devices 15 in response to commands from the controller 26. In particular, hydraulic drive system 13 may include a prime mover 30 configured to generate a power output, and a transmission system 31 operatively coupled thereto to receive, convert, and/or transmit the power output in a useful manner to traction devices 15.

The prime mover 30 may be an internal combustion engine or any other type of power source. The prime mover 30 may have multiple subsystems (not shown) that cooperate to produce power output. The subsystems may include, for example, a fuel system, an air induction system, an exhaust system, a lubrication system, a cooling system, and any other appropriate system. The controller 26 may be configured to regulate the operation of any one or more of the subsystems of the prime mover 30.

A prime mover speed sensor 42 may be associated with prime mover 30 to sense the output speed of the prime mover 30. More specifically, the sensor 42 may defect the rotational velocity of the shaft 32 that couples the prime mover 30 to the pump 34a. The prime mover speed sensor 42 may embody any type of sensor. In one embodiment, the prime mover speed sensor 42 may be mounted on a rotating component of the prime mover 30, such as a crankshaft, flywheel, or the like. Signals produced by the prime mover speed sensor 42 may be processed by the controller 26 to determine the speed of the prime mover 30, such as the rotations per minute or other purposes as desired.

The transmission system 31 may function as a continuously variable hydrostatic transmission having an infinite number of available torque-to-speed output ratios (i.e., virtual gears) within its continuous overall range. The transmission system 31 may include at least one pump 34a, 34b operatively coupled to receive the output of the prime mover 30. Two pumps 34a, 34b are depicted in FIG. 2, with the pumps 34a, 34b being operatively hydraulically connected to power the motors 35a, 35b respectively via first hydraulic lines 37a, 37b and second hydraulic lines 38a, 38b. The motors 35a, 35b may be driven by pressurized hydraulic fluid from the pumps 34a, 34b respectively to rotate the traction devices 15 and propel the machine 10. The motors 35a, 35b may be directly or indirectly coupled to the fraction devices 15 to propel the machine 10. As described in more detail below, one or more operational characteristics of the pumps 34a, 34b and/or the motors 35a, 35b may be directly regulated by the controller 26. Further, while two pumps 34a, 34b and two motors 35a, 35b are shown, only a single pump and motor combination is necessary.

Each pump 34a, 34b may be a variable displacement pump with the displacement controlled by the controller 26. In one embodiment, signals from the controller 26 may be used to control or adjust the displacement of the pumps 34a, 34b. Each pump 34a, 34b may direct pressurized hydraulic fluid to and from one of the motors 35a, 35b in two different directions via the first and second hydraulic lines 37a, 37b, 38a, 38b to operate the motors 35a, 35b in forward and reverse directions. Each pump 34a, 34b may include a stroke-adjusting mechanism, for example a swashplate, the position of which is hydro- or electro-mechanically adjusted to vary the displacements of the pumps 34a, 34b. The displacement of each pump 34a, 34b may be adjusted from a zero displacement position, at which substantially no fluid is discharged from the pumps 34a, 34b, to a maximum displacement position, at which fluid is discharged from the pumps 34a, 34b at a maximum rate. The displacement of each pump 34a, 34b may be adjusted so the flow is either into first hydraulic lines 37a, 38a or into second hydraulic lines 38a, 38b so that the pumps 34a, 34b may drive motors 35a, 35b in both forward and reverse directions, depending on the direction of fluid flow. The pumps 34a, 34b may be operatively connected to the prime mover 30 by, for example, the shaft 32, a belt, or in any other suitable manner.

Each motor 35a, 35b may be driven to rotate by a fluid pressure differential generated by the pumps 34a, 34b and supplied through first hydraulic lines 37a, 37b and the second hydraulic lines 38a, 38b. Specifically, the motors 35a, 35b may include first and second chambers (not shown) located on opposite sides of a pumping mechanism such as an impeller, plunger, or series of pistons (not shown). Referring to the motor 35a, when the first chamber is filled with pressurized fluid from pump 34a via the first hydraulic line 37a and the second chamber is drained of fluid returning to the pump 34a via second hydraulic line 38a, the pumping mechanism may be urged to move or rotate in a first direction (e.g., in a forward traveling direction). Conversely, when the first chamber is drained of fluid and the second chamber is filled with pressurized fluid, the pumping mechanism may be urged to move or rotate in an opposite direction (e.g., in a rearward traveling direction). The flow rate of fluid into and out of the first and second chambers may determine an output velocity of the motors 35a, 35b, while a pressure differential across the pumping mechanism may determine an output torque.

In one embodiment, each motor 35a, 35b may be a fixed, multi-speed motor. In such case, the motors 35a, 35b have a finite number configurations or displacements (e.g., two) between which the motors 35a, 35b may be shifted. The motors 35a, 35b may thus operate as fixed displacement motors with a plurality of distinct displacements. For example, a two-speed motor will thus have a first displacement and a second displacement so that the motor has two operating speeds and torque ranges. As depicted in FIG. 2, each motor 35a, 35b may be shifted between the different displacements (and thus speeds) by adjusting the hydraulic valves 39 that are controlled by the controller 26 and operatively connected to the motors 35a, 35b. The motors 35a, 35b are linked to the controller 26. Other manners of shifting the motors 35a, 35b are contemplated and will be apparent to those skilled in the art. In some instances, a variable displacement motor may be used.

In some embodiments, the motors 35a, 35b may also operate to create a pressure differential within transmission system 31 that functions to slow the machine 10 and/or recover energy during deceleration of the machine 10. In particular, there may be times when the fraction devices 15 rotate at a faster speed and/or with greater torque than the motors 35a, 35b would otherwise be driven by fluid from the pumps 34a, 34b. In this situation, the motors 35a, 35b may function as a pump, pressurizing fluid directed back to the pumps 34a, 34b, which may function as a motor in this situation. When the motors 35a, 35b pressurize fluid, energy imparted to the motors 35a, 35b by traction devices 15 may be dissipated, thereby slowing the rotation of traction devices 15. The pressurized fluid directed from the motors 35a, 35b back to the pumps 34a, 34b may reduce the load placed on the prime mover 30 by the pumps 34a, 34b and, in some situations, even be used to drive the prime mover 30.

The machine 10 may also be equipped with a braking device such as service brakes (not shown) that is linked to the brake input 21 via the controller 26. The braking device may be operatively associated with one or more of the traction devices 15 of the machine 10 and may be configured to retard the motion of the machine 10 when commanded to do so by the controller 26 (e.g., in response to a braking signal received via the brake input 21). In one embodiment, the braking device may include a hydraulic pressure-actuated mechanism such as, for example, a disk brake or a drum brake that is disposed adjacent a wheel of one of the traction devices 15.

In some instances, pressing the brake input 21 may merely reduce the input command to the pumps 34a, 34b to reduce the speed of the machine 10. In other instances, such as, for example, when rapid deceleration is desired, pressing the brake input 21 may also result in the application of the braking device.

The controller 26 is linked to each motor 35a, 35b respectively and can determine the rotational speed of the motors 35a, 35b. The controller 26 may utilize the speed of the motors 35a, 35b to determine the travel speed of the machine 10. In other instances, the travel speed of the machine 10 may be determined by other mechanisms, such as a GPS device.

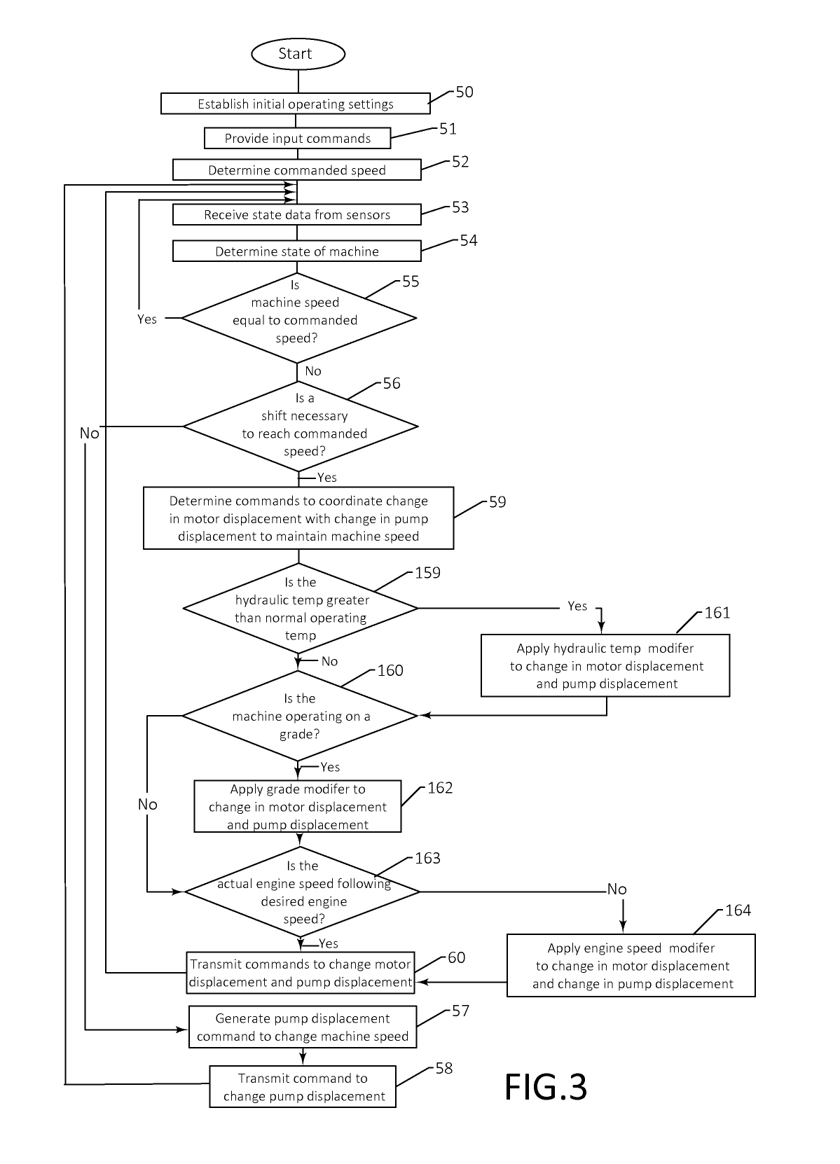

FIG. 3 is a flowchart that depicts the operation of the hydraulic drive system 13. At stage 50, an operator may establish initial operating settings for the machine 10, such as by controlling the transmission input 22 and the speed input 23. The operator may use the transmission input 22 to select a virtual gear in which the machine 10 will operate. For example, the operator may choose to operate the machine 10 in a virtual first gear with the highest torque output range and a corresponding lowest travel speed range. In other instances, the transmission input 22 may be utilized to select transmission operation in which the hydraulic drive system 13 operates initially in a virtual first gear and subsequently shifts to a virtual second gear to maximize the efficiency and performance of the machine 10. If desired, the machine 10 may operate in this mode by default.

An operator may use the speed input 23 to select a maximum travel speed of the machine 10. It may be desirable to set the maximum travel speed command to be less than the maximum possible travel speed of the machine 10. This may be desirable, for example, in instances in which an operator knows that an operation of the machine 10 may be optimized at a particular speed. In such case, the operator may set the maximum travel speed command equal to the desired speed for the operation. This permits the operator to maintain the throttle input 20 at its maximum displacement to maintain the machine at the desired travel speed. The speed input 23 may include pre-set buttons or other input devices.

At stage 51, the operator may provide input commands in the form of displacing the throttle input 20 and displacing the brake input 21. By moving the throttle input 20, the operator may generate a throttle input command that is indicative of the desired travel speed and direction of the machine 10. Similarly, movement of the brake input 21 may generate a brake input command that is indicative of a desired deceleration or reduction in acceleration of the machine 10. The throttle signals from the throttle input 20 and brake signals from the brake input 21 may be received by the controller 26 and utilized to determine the desired or commanded travel speed of the machine 10 at stage 52. To do so, the controller 26 may utilize a data map to determine the desired or commanded speed based upon the displacements of the throttle input 20 and the brake input 21.

At stage 53, the controller 26 may receive state data from sensors 41-44 and any other sensors (not shown) associated with the machine 10. The controller 26 may use the state data at stage 54 to determine the state of the machine 10. For example, the controller 26 may receive output speed data from the prime mover speed sensor 42 (FIG. 2) that is indicative of the output speed of the prime mover 30. In some instances, the controller 26 may utilize the output speed data from the prime mover speed sensor 42 to determine the revolutions per minute of the prime mover 30. The controller 26 may also receive motor speed data from the motors 35a, 35b. The controller 26 may use the motor speed data to determine the speed and direction of rotation of the motors 35a, 35b as indicated schematically in FIG. 2.

In one embodiment, the displacement of the pumps 34a, 34b may be determined based upon the electrical signals used to control the stroke-adjusting mechanism. For example, during assembly or set-up, signals may be sent to the pumps 34a, 34b by the controller 26 and the position of the stroke-adjusting mechanisms noted and the signal and displacement recorded to establish a data map that correlates the electrical signal with the displacement of the pumps 34a, 34b. More specifically, during the assembly or set-up process, the signals may be noted when the pumps 34a, 34b are at the zero displacement position and each of the maximum displacement positions. In addition, intermediate positions may also be established as part of the data map. With such a set-up process, the pumps 34a, 34b do not need a dedicated sensor for monitoring their displacement but rather the controller 26 may utilize the electrical signals used to control the pumps 34a, 34b to determine the displacement of each. In an alternate configuration, pump displacement sensors (not shown) may be associated with each pump 34a, 34b.

The displacement or position of the motors 35a, 35b may be determined based upon the signals controlling by the motor sent by the controller 26. During assembly or set-up, signals may be provided that are sufficient to position the motors 35a, 35b in their first position and their second position and the signals recorded as part of the data map. More specifically, signals may be recorded to shift the hydraulic valves 39 to change the flow of hydraulic fluid to the motors 35a, 35b through the valves 39 to shift the motors 35a, 35b between their first and second displacement positions.

If desired, the controller 26 may utilize the speed of the motors 35a, 35b to determine the speed of the machine 10 relative to a ground reference. In the alternative, other means for determining machine travel speed may be utilized, such as machine speed sensor 41 (FIG. 1) or a GPS device.

At the decision stage 55, the controller 26 may determine whether the machine is operating at the commanded or desired travel speed. To do so, the controller 26 may compare the commanded speed to the travel speed of the machine 10 as determined from the speed of the motors 35a, 35b or the machine speed sensor 41. If the machine 10 is operating at the commanded speed, no additional changes to the prime mover 30 speed, displacement of the pumps 34a, 34b, or speed of the motors 35a, 35b are necessary.

If the machine 10 is not operating at the commanded speed, the controller 26 may determine at the decision stage 56 whether a shift in the displacement of one or both motors 35a, 35b is necessary to reach the commanded speed. The controller 26 may include a data map that correlates commanded speeds with the current travel speed of the machine 10, displacements of pumps 34a, 34b, and the speeds and displacements of the motors 35a, 35b. As a result, based upon the commanded speed determined at stage 52 and the state of the machine 10 as determined at stage 54, the controller 26 may determine whether a shift is necessary to reach the commanded speed at stage 56.

If no shift or shifts are necessary even though the travel speed of the machine 10 does not match the commanded speed, the controller 26 may generate a pump displacement command at stage 57 to change the displacement of one or both of the pumps 34a, 34b. The pump displacement command may be transmitted at stage 58 to change the displacement(s) of one or both the pumps 34a, 34b. The change in the pump displacement will change the flow rate within the first hydraulic lines 37a, 37b and second hydraulic lines 38a, 38b, which will result in a change (either an increase or a decrease) in the motor speed(s) to change the travel speed of the machine 10 (either an increase or a decrease) towards the commanded speed. The controller 26 may repeatedly perform the stages 53-58 until either the machine 10 is traveling at the commanded speed at stage 55 or a shift in the displacement of at least one of the motors 35a, 35b is necessary at the decision stage 56.

If a shift in the displacement of one or both of the motors 35a, 35b is necessary at the decision stage 56, the controller 26 may determine the commands necessary to coordinate the shift in motor displacement and a change in the pump displacement at stage 59 to maintain the current travel speed of the machine 10. In other words, the controller 26 operates to reduce or eliminate any acceleration or deceleration of the machine 10 while changing the motor displacement. This may be desirable in some operations to increase the performance and/or efficiency of the operation of the machine 10. For example, when operating a compactor, a rapid or abrupt change in speed of the traction devices 15 may result in degradation of the finished surface or mat upon which the machine 10 is operating. As a result, the finished surface may require re-working to repair the damage caused by the change in speed of the traction devices 15 of the machine 10.

It should be noted that the motors 35a, 35b may have a finite number of fixed displacements and thus a shift in displacement of the motor may change its rotational speed. If the motors 35a, 35b are directly coupled to the traction devices 15, a rapid or abrupt change in the travel speed of the machine 10 may occur upon shifting the displacement of one or both of the motors 35a, 35b. Accordingly, the controller 26 may be configured to coordinate the changes in displacements of one or both pumps 34a, 34b and one or both motors 35a, 35b to avoid such a sudden acceleration or deceleration.

To coordinate the changes in displacement of the pumps 34a, 34b and the motors 35a, 35b, the controller 26 may control the magnitude of the change in the pump displacement as well as the timing of the changes in pump displacement and motor displacement to maintain the output speed of the motors 35a, 35b and thus the travel speed of the machine 10. For example, when up-shifting to increase the potential top speed of the machine 10 (i.e., decreasing the displacement of one or both of the motors 35a, 35b), the controller 26 may be configured to reduce the displacement of the pumps 34a, 34b before reducing the displacement of the motors 35a, 35b to reduce the pressure of the hydraulic fluid (within either the first hydraulic lines 37a, 37b or the second hydraulic lines 38a, 38b) that is driving the motors 35a, 35b. This reduction in pressure is desirable as the reduction in the displacement of the motors 35a, 35b may otherwise cause a rapid increase in the rotational speed of the motors 35a, 35b. It should be noted that due to lag times in the responses of the components within the hydraulic drive system 13, the reduction in the displacement of the pumps 34a, 34b may be timed so that the reduction does not materially affect the rotational speed of the motors 35a, 35b.

Similarly, when downshifting to decrease the potential top speed of the machine 10 and increase the potential torque, the displacement of the motors 35a, 35b will be increased. In such case, without the desired coordination of the changes to the displacement of the pumps 34a, 34b and the motors 35a, 35b, the hydraulic pressure at the motors 35a, 35b may decrease and result in a rapid decrease in the rotational speeds of the motors 35a, 35b. Accordingly, the controller 26 may delay shifting the motors 35a, 35b to the increased displacement while increasing the displacement of the pumps 34a, 34b. The increase in displacement of the pumps 34a, 34b will temporarily increase the pressure within the hydraulic drive system 13 to compensate for the increase in displacement of the motors 35a, 35b and thus reduce that impact of the change in motor displacement on the rotational speed of the motors 35a, 35b.

It should be noted that the timing of the changes in the displacements of the pumps 34a, 34b and the motors 35a, 35b may be dependent upon the types of components used in the transmission system. For example, the responsiveness of the pumps 34a, 34b and the motors 35a, 35b may depend upon the configuration, size, and even the manufacturer of the components. In addition, the diameter and length of the hydraulic lines 37a, 37b, 38a, 38b may also affect the responsiveness of the components and thus the required timing to create a smooth shifting process.

Certain factors or parameters have been surprisingly found to be important when determining what modifications to the pump displacement and motor displacement are necessary to adjust the current machine speed to the desired machine speed at stage 59. The factors or parameters may include temperature (and/or viscosity) of the hydraulic fluid, whether the machine 10 is operating on a grade and the magnitude of the grade, and whether the prime mover 30 is operating at the desired speed. In one aspect, the monitoring of these factors may be a part of stage 59, as indicated by stages 159-164.

Turning to stage 159, the temperature of the hydraulic fluid in the hydraulic drive system 13 is measured using a temperature sensor 43 (FIG. 2) and compared to a predetermined normal operating temperature normal operating temperature ranges for the hydraulic fluid. If the sensed temperature of the hydraulic fluid falls outside of the predetermined normal operating temperature range at stage 159, the controller 26 then applies a temperature modifier to change the displacement of one or both motors 35a, 35b and one or both pumps 34a, 34b at stage 161. Stage 161 may occur before, after or concurrently with stages 160, 162. Referring to stage 160, the machine 10 is operating on a grade as detected by the grade sensor 44 (FIGS. 1 and 2), the controller 26 applies a grade modifier to change the displacement(s) of at least one of the motors 35a, 35b and at least one of the pumps 34a, 34b at stage 162. If for example, if the machine 10 is proceeding up a grade at stage 160, the grade modifier applied by the controller 26 may decrease or shift the displacement of at least one of the motors 35a, 35b and/or decrease the displacement of one or more of the pumps 34a, 34b at stage 162. In contrast, if the machine 10 is proceeding down a grade, the grade modifier applied by the controller 26 may increase the displacement of at least one of the motors 35a, 35b and/or the pumps 34a, 34b at stage 162. If the machine 10 is not operating on a grade at stage 160, the shift logic then proceeds to stage 163 and the actual speed of the engine or prime mover 30 is measured by the sensor 42.

At stage 163, the measured prime mover speed is then compared to the desired prime mover speed or an acceptable prime mover speed range within which the desired prime mover speed falls. The desired prime mover speed may be recalculated by the controller 26 at stage 163 if a temperature modifier and/or a grade modifier has been applied. If the measured prime mover speed is within the acceptable prime mover speed range at stage 163, the controller 26 proceeds on to stage 60. If the measured prime mover speed does not fall within the acceptable prime mover speed range at stage 163, the controller applies an prime mover speed modifier at stage 164 to change the displacement of at least one of the motors 35a, 35b and/or at least one of the pumps 34a, 34b. The order of stages 161, 162, 164 is not critical and the order presented in FIG. 3 may be changed or stages 161, 162, 164 may be carried out simultaneously.

At stage 60, the controller 26 determines the commands that lead to changes in the displacement of the pumps 34a, 34b and/or the displacement of the motors 35a, 35b to attain, maintain or return to the desired prime mover speed.

The speed of the prime mover 30 is also a variable that impacts the operation of the pumps 34a, 34b and thus the shifting of transmission system 31. However, it may be undesirable to vary the prime mover speed as part of the shifting process if the prime mover 30 is powering other systems in addition to the hydraulic drive system 13. Regardless, the timing of the changes in displacements of the pumps 34a, 34b and the motors 35a, 35b may also be dependent on the prime mover speed. Each of the factors that may affect the timing of the changes in displacement and thus the shifting process may be accounted for in a data map within the controller 26.

The amount of acceleration or deceleration that may be acceptable for a particular hydraulic drive system 13 may depend on the type of the machine 10 and the type of operation. Accordingly, as used herein, maintaining the travel speed of the machine 10 is not absolute but rather relatively small amounts of change in travel speed are to be expected. For example, when operating a compactor on asphalt, a change in speed of less than ±0.25 kilometers per hour may be considered “maintaining” the travel speed of the machine. In another example, such as when operating a loader, a greater change in speed may be considered maintaining the travel speed of the machine. It is contemplated that other values and ranges of acceleration and deceleration may be considered acceptable depending on the type of machine and operation involved.

### INDUSTRIAL APPLICABILITY

The hydraulic drive system 13 may be applicable to any machine 10 having a hydraulic transmission system 31. The hydraulic drive system 13 includes one or more variable displacement pumps 34a, 34b and a corresponding number of variable displacement motors 35a, 35b. The controller 26 may coordinate the amount and timing of changes in the displacement of the pumps 34a, 34b with a shift in the displacement of the motors 35a, 35b to reduce or eliminate any rapid or abrupt momentary acceleration or deceleration of the motors 35a, 35b that may occur when shifting the motors 35a, 35b between two displacements. With the transmission system 31, the machine 10 may maximize the efficiency of its operation by selection of desired gear ratios and shift points without rapid or abrupt changes in the rotational speed of the motors 35a, 35b.

The drive system further includes a prime mover 30 with one or more pumps 34a, 34b being driven by the prime mover 30. The motors 35a, 35b may be hydraulically connected to and driven by respective pumps 34a, 34b. The controller 26 may be configured to determine a travel speed of the machine 10 and determine a motor displacement command to shift one or both motors 35a, 35b from one displacement to another displacement. The controller 26 may be further configured to determine a pump displacement command to change the displacement of the pumps 34a, 34b and to coordinate transmittal of the pump displacement command(s) and the motor displacement command(s) to maintain the travel speed of the machine 10 while changing the displacement of one or both pumps 34a, 34b and the corresponding shifting of one or both motors 35a, 35b from the first motor displacement to the second motor displacement. The controller 26 may also apply modifiers to changes in the displacement of the motors 35a, 35b and pumps 34a, 34b if the temperature of the hydraulic fluid falls outside of a predetermined temperature range (sensor 43), if the machine 10 is proceeding up or down a grade (sensor 44) or if the speed of the prime mover 30 falls outside of a range based on the desired speed of the prime mover 30 (sensor 42).

1. A drive system for a machine, comprising:
a prime mover coupled to a variable displacement pump, the pump hydraulically driving a variable displacement motor with hydraulic fluid;
a controller communicatively linked to the motor, the pump, a travel speed sensor, an operator interface, a hydraulic fluid temperature sensor, a grade sensor and a primer mover speed sensor, the controller configured to
determine a travel speed of the machine from at least one signal communicated to the controller from the travel speed sensor;
determine a commanded speed of the machine based on operator input communicated to the controller from the operator interface;
compare the commanded speed to the travel speed, and if the travel speed differs from the commanded speed by more than a predetermined amount, determine a motor displacement command to change a displacement of the motor and determine a pump displacement command to change a displacement of the pump; and
apply at least one modifier to at least one of the motor displacement command and the pump displacement command, the at least one modifier selected from the group consisting of a hydraulic fluid temperature modifier based on at least one signal communicated to the controller from the hydraulic fluid temperature sensor, a grade modifier based on at least one signal communicated to the controller from the grade sensor and a prime mover speed modifier based on at least one signal communicated to the controller from the prime mover speed sensor.

2. The drive system of claim 1 wherein the controller is further configured to coordinate transmittal of the pump displacement command to the pump and the motor displacement command to the motor to maintain the travel speed of the machine while changing the displacements of the pump and motor.

3. The drive system of claim 1 wherein the controller is further configured to
determine if a temperature of the hydraulic fluid falls outside of a predetermined temperature range based on the at least one signal communicated to the controller from the hydraulic fluid temperature sensor and if the temperature of the hydraulic fluid falls outside of the predetermined temperature range, calculating and applying the temperature modifier to at least one of the motor or pump displacement commands.

4. The drive system of claim 1 wherein the controller is further configured to
determine if the machine is travelling on a non-horizontal grade based on the at least one signal communicated to the controller from the grade sensor, and if the machine is travelling on a non-horizontal grade, determining and applying the grade modifier to at least one of the motor or pump displacement commands.

5. The drive system of claim 1 wherein the controller is further configured to
determine if an actual speed of the prime mover falls within a predetermined range that includes a desired speed of the prime mover, the desired speed of the prime mover calculated from the operator input, and if the actual speed of the prime mover does not fall within the predetermined range, determining and applying the prime mover speed modifier to at least one of the motor or pump displacement commands.

6. The drive system of claim 1 wherein the controller is further configured to
determine if a temperature of the hydraulic fluid falls outside of a predetermined temperature based on the at least one signal communicated to the controller from the hydraulic fluid temperature sensor and if the temperature of the hydraulic fluid falls outside of the predetermined temperature range, calculating and applying the temperature modifier to at least one of the motor or pump displacement commands;
determine if the machine is travelling on a non-horizontal grade based on the at least one signal communicated to the controller from the grade sensor, and if the machine is travelling on a non-horizontal grade, determining and applying the grade modifier to at least one of the motor or pump displacement commands; and
determine if an actual speed of the prime mover falls within a predetermined range that includes a desired speed of the prime mover, the desired speed of the prime mover calculated from the operator input, and if the actual speed of the prime mover does not fall within the predetermined range, determining and applying the prime mover speed modifier to at least one of the motor or pump displacement commands.

7. The drive system of claim 1 wherein the controller is further configured to determine a magnitude of the pump displacement command and a timing of the pump displacement command relative to the motor displacement command.

8. The drive system of claim 7 wherein the pump displacement command occurs prior to the motor displacement command.

9. The drive system of claim 7 wherein the pump displacement command occurs after the motor displacement command.

10. The drive system of claim 1 wherein the variable displacement motor includes first and second displacements.

11. The drive system of claim 1 wherein the variable displacement motor is a continuously variable displacement motor.

12. The drive system of claim 1 wherein the operator interface further includes a throttle input movable by an operator to generate a throttle input command communicated to the controller to indicate the commanded speed of the machine.

13. The drive system of claim 10 wherein the controller is further configured to determine whether a shift of the motor from the first displacement to the second displacement is required to reach the desired travel speed of the machine.

14. The drive system of claim 12 wherein the operator interface further includes a speed input movable by an operator to select a maximum allowable speed of the machine and wherein the throttle input indicates the commanded speed of the machine as a function of the maximum allowable speed of the machine.

15. The drive system of claim 1 further including a brake input movable by an operator to reduce the commanded speed of the machine.

16. A controller-implemented method of driving a machine, comprising:
determining a travel speed of the machine;
driving a variable displacement pump with a prime mover;
determining a pump displacement command to change a displacement of the pump;
hydraulically driving a variable displacement motor with the pump, the motor being adjustable between at least a first displacement and a second displacement;
determining a motor displacement command to shift the motor from the first motor displacement to the second motor displacement;
detecting at least one operating variable selected from the group consisting of hydraulic fluid temperature, grade on which the machine is travelling and speed of the prime mover; and
applying at least one modifier to at least one of the motor displacement command and the pump displacement command, the at least one modifier selected from the group consisting of a hydraulic fluid temperature modifier based on the hydraulic fluid temperature, a grade modifier based on the grade on which the machine is travelling and a prime mover speed modifier based on the speed of the prime mover.

17. The method of claim 16 further including coordinating transmittal of the pump displacement command and the motor displacement command to maintain the travel speed of the machine while changing the displacement of the pump and shifting the motor from the first motor displacement to the second motor displacement.

18. The method of claim 16 wherein the pump displacement command occurs prior to the motor displacement command.

19. The method of claim 16 wherein the pump displacement command occurs after the motor displacement command.

20. A machine, comprising:
a prime mover coupled to a variable displacement pump, the pump driving a variable displacement motor with hydraulic fluid, the motor including at least a first motor displacement and a second motor displacement, the motor driving at least one traction device;
a controller communicatively linked to the motor, the pump, a prime mover speed sensor, a travel speed sensor, a grade sensor, a hydraulic fluid temperature sensor and an operator interface, the controller configured to:
determine a travel speed of the machine from at least one signal communicated to the controller from the travel speed sensor;
determine a commanded speed of the machine based on operator input communicated to the controller from the operator interface;
compare the commanded speed to the travel speed, and if the travel speed differs from the commanded speed by more than a predetermined amount, determine a motor displacement command to change displacement of the motor from a first motor displacement to a second motor displacement and determine a pump displacement command to change displacement of the pump from a first pump displacement to a second pump displacement;
determine if a temperature of the hydraulic fluid falls outside of a predetermined temperature range based on the at least one signal communicated to the controller from the hydraulic fluid temperature sensor and if the temperature of the hydraulic fluid falls outside of the predetermined temperature range, calculating and applying a temperature modifier to at least one of the motor or pump displacement commands;
determine if the machine is travelling on a non-horizontal grade based on the at least one signal communicated to the controller from the grade sensor, and if the machine is travelling on a non-horizontal grade, determining and applying the grade modifier to at least one of the motor or pump displacement commands;
determine if an actual speed of the prime mover falls within a predetermined range that includes a desired speed of the prime mover, the desired speed of the prime mover calculated from the operator input, and if the actual speed of the prime mover does not fall within the predetermined range, determining and applying a prime mover speed modifier to at least one of the motor or pump displacement commands; and
coordinate transmittal of the pump and motor displacement commands to maintain the travel speed of the machine while changing the displacement of the pump from the first to the second pump displacement and changing the displacement of the motor from the first to the second motor displacement.
